(19) United States
(12) Patent Application Publication
(10) Pub. No.: US 2016/0070287 A1
(43) Pub. Date: Mar. 10, 2016

(54) INTELLIGENT POWER MONITOR SYSTEM AND IMPLEMENTING METHOD THEREOF

(71) Applicant: TSU-CHING CHIN, Hsinchu County (TW)

(72) Inventor: TSU-CHING CHIN, Hsinchu County (TW)

(21) Appl. No.: 14/849,510

(22) Filed: Sep. 9, 2015

(30) Foreign Application Priority Data
Sep. 10, 2014 (TW) 103131172

(51) Int. Cl. G05F 1/66; G05B 15/02; H04W 8/00

(52) U.S. Cl. CPC G05F 1/66; H04W 8/005; G05B 15/02

(57) ABSTRACT

An intelligent power monitor system and its implementing method are disclosed. The intelligent monitor system includes a power monitor device and a mobile communication device. The power monitor device is disposed between a power supply end and a power user end. The mobile communication device and the power monitor device form an information connection. When the power supply end supplies power to the power user end, the power monitor device detects power use data. When the mobile communication device is carried outside detection range of a wireless signal, the power monitor device calculates power-off time and controls the power loop switch module to form an open status. With convenient automatic power-off method as disclosed, power saving as well as enhancing product safety are achieved.

### TECHNICAL FIELD

The present invention relates to an intelligent monitor system and its implementing method and more particularly relates an intelligent monitor system and its implementing method that co-works with a mobile communication device and use a wireless signal of the mobile communication device to determine power-off operation.

### BACKGROUND

In recent years, more and more government and private organizations encourage power saving policy and spread related concept and habit. Meanwhile, more and more people realize the importance of power saving particularly under global warming problem.

Therefore, product manufacturers improve various products to increase their energy efficiency. Nevertheless, due to user ignorance, like forgetting to turn off power, many products keeps operating even nobody is using them. Under such condition, even products have great energy efficiency, there is still power waste.

Consequently, there are various auxiliary energy saving products released on the market, including intelligent power plug, intelligent socket and even intelligent power saving service. In addition to home appliance devices, traffic apparatuses like motorcycles or cars also use lot of energy. For example, some users leave their cars without turning off power, which causes over discharging of batteries and even safety problem. As such, there are some power management devices for monitoring power use status of a remote device via a telecommunication network or the Internet.

In such power management devices, users need to dial phones or execute computer devices to issue commands to a remote power management device. After remote power management devices receive such commands from phones via telecommunication networks or from computer device control web pages via the Internet, corresponding monitor and control actions are applied. It is still very complicated and thus discourages users to use them and the energy waste problem still exists. Therefore, it is critical to design a convenient operation flow to really achieve power saving and safety enhancement.

### SUMMARY OF INVENTION

One of major objectives of the present invention includes providing an intelligent power monitor system and its implementing method to achieve automatic power-off by detecting a wireless signal of a mobile communication device as power-on or power-off basis.

To achieve the aforementioned objective, an embodiment according to the present invention is an intelligent power monitor system. The intelligent monitor system includes a power monitor device and a mobile communication device.

The power monitor device is disposed between a power supply end and at least one power user end. The power monitor device has a first micro-processing module, a first signal transceiver module and a power loop switch module. The first micro-processing module is respectively electrically connected to the first signal transceiver module and the power loop switch module. The first micro-processing module is used for controlling the power loop switch module to form a close status or an open status. The first signal transceiver module is used for detecting a wireless signal. When the first signal transceiver module detects the wireless signal, the first micro-processing module controls the power loop switch module to form the close status. When the first signal transceiver module does not detect the wireless signal, the first micro-processing module controls the power loop switch module to form the open status.

The mobile communication device has a second micro-processing module, a second signal transceiver module electrically connected to the second micro-processing module and a power monitor setting module connected with the second micro-processing module via information. After the power monitor setting module is executed, the second signal transceiver module sends the wireless signal.

As mentioned above, the power monitor device may have a power detection module connected with the first micro-processing module of the power monitor device via information. The power detection module may be used for detecting power use status of the power user end to generate power use data.

As mentioned above, the power monitor device may have a data storage module connected with the first micro-processing module of the power monitor device via information, the data storage module may be used for storing the power use data.

As mentioned above, the data storage module stores a notification message. The first micro-processing module of the power monitor device may enable the first signal transceiver module to send the notification message to the mobile communication device.

As mentioned above, the power monitor device may have a timer module connected with the first micro-processing module via information and the timer module is used for setting and calculating a specific time period.

As mentioned above, when a time period for the power monitor device not detecting the wireless signal equals or exceeds the specific time period, the first micro-processing module controls the power loop switch module to form the open status.

As mentioned above, the mobile communication device has a positioning module connected with the second micro-processing module via information. When the first signal transceiver module of the power monitor device does not detect the wireless signal, the positioning module locates the mobile communication device to obtain a coordinate position.

As mentioned above, the power monitor device may have a first wireless transmission module. The first wireless transmission module is electrically connected with the first micro-processing module. The mobile communication device may have a second wireless transmission module electrically connected with the second micro-processing module.

As mentioned above, the mobile communication device is information connected to a service center server via the second wireless transmission module. The service center server is information connected to the power monitor device via the first wireless transmission module to control the power monitor device.

To achieve the aforementioned objective, another embodiment of the present invention is an implementing method of an intelligent power monitor system. A power monitor device of the intelligent power monitor system is disposed between a power supply end and a power user end. The implementing method may include following steps.

A device pairing step includes that a mobile communication device drives a second signal transceiver module via a power monitor setting module to send a wireless signal. A first signal transceiver module of the power monitor device receives the wireless signal to form a connection status by establishing an information connection with the mobile communication device.

A wireless signal detection step includes that the power monitor device keeps information connection with the mobile communication device for the first signal transceiver module of the power monitor device to continuously receive the wireless signal sent by the second signal transceiver module of the mobile communication device. Under the connection status, a first micro-processing module of the power monitor device controls a power loop switch module of the power monitor device to form a close status.

A power-off step includes that when the first signal transceiver module of the power monitor device does not detect the wireless signal, i.e. when the power monitor device and the mobile communication device is under a disconnection status, the first micro-processing module controls the power loop switch module to form an open status.

A power-recovery step may be continued after the power-off step. The power-recovery step includes that when the first signal transceiver module of the power monitor device detects the wireless signal again to recover the connection status between the power monitor device and the mobile communication device, the power monitor setting module uses the second signal transceiver module to send a driver signal to drive the first micro-processing module to control the power loop switch module to switch from the open status to the close status.

When the power loop switch module switches from the open status to the close status, the first micro-processing module of the power monitor device enables the first signal transceiver module to send a notification message stored in a data storage module to the mobile communication device.

The power-off step includes a power detection step. In the power detection step, when the first signal transceiver module of the power monitor device does not detect the wireless signal, a power detection module of the power monitor device starts detecting power use status to generate power use data. When the power use data equal or exceed predetermined use data predetermined by the power detection module, the first micro-processing module controls the power loop switch module to form the open status.

The power-off step may include a timer step. In the timer step, when the first signal transceiver module of the power monitor device does not detect the wireless signal, the timer module of the power monitor device starts counting power-off time. When the power-off time equals or exceeds a specific time period predetermined by the timer module, the first micro-processing module controls the power loop switch module to form the open status.

### BRIEF DESCRIPTION OF DRAWINGS

FIG. 1 is a first system diagram of a preferred embodiment according to the present invention;

FIG. 2 is a second system diagram of a preferred embodiment according to the present invention;

FIG. 3A is a first power loop diagram of a preferred embodiment according to the present invention;

FIG. 3B is a second power loop diagram of a preferred embodiment according to the present invention;

FIG. 4 is a first implementation diagram of a preferred embodiment according to the present invention;

FIG. 5 is a second implementation diagram of a preferred embodiment according to the present invention;

FIG. 6 is a third implementation diagram of a preferred embodiment according to the present invention;

FIG. 7 is a first implementation diagram of another embodiment according to the present invention;

FIG. 8 is a second implementation diagram of another embodiment according to the present invention;

FIG. 9 is a third implementation diagram of another embodiment according to the present invention;

FIG. 10 is a fourth implementation diagram of another embodiment according to the present invention;

FIG. 11 is an implementation flowchart of a preferred embodiment according to the present invention;

FIG. 12 is a first system diagram of another embodiment according to the present invention;

FIG. 13 is second system diagram of another embodiment according to the present invention;

FIG. 14 is a third system diagram of another embodiment according to the present invention;

FIG. 15 is a first implementation diagram of another system structure embodiment according to the present invention; and

FIG. 16 is a second implementation diagram of another system structure embodiment according to the present invention.

### DETAILED DESCRIPTION

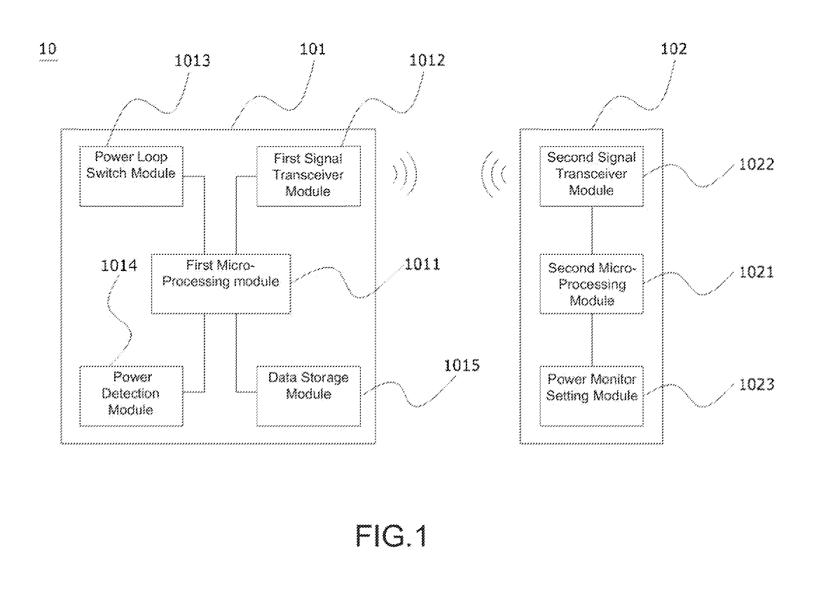

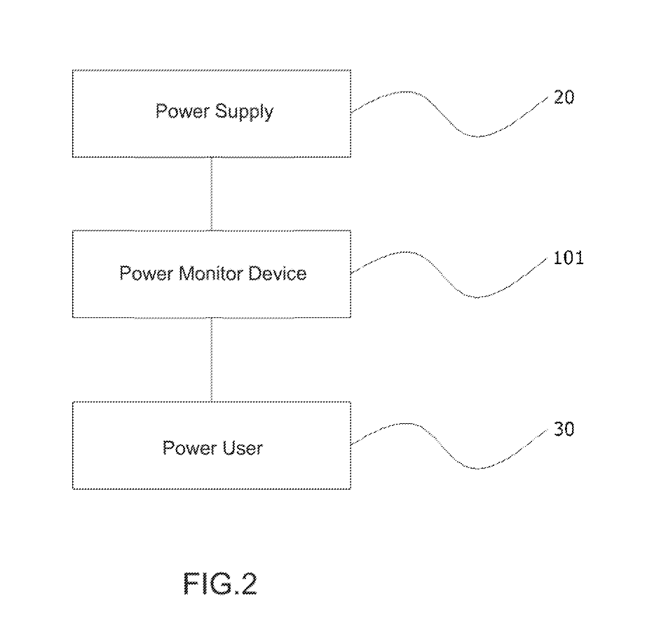

Please refer to FIG. 1, which is a first system diagram of a preferred embodiment. As illustrated in FIG. 1, an intelligent power monitor system 10 includes a power monitor device 101 and a mobile communication device 102. Please refer to FIG. 2, which illustrates a second system diagram of a preferred embodiment. As illustrated in FIG. 2, the power monitor device 101 is disposed between a power supply end 20 and a power user end 30. The power user end 30 is an electronic device that needs power supply to be activated like a motorcycle, a car, an air condition device, a dehumidifier, a heater, a computer, a television or any other devices.

The power supply end 20 is a power supplying device for supplying power to the power user end 30. The power monitor device 101 has a first micro-processing module 1011. The power monitor device 101 also has a first signal transceiver module 1012, a power loop switch module 1013, a power detection module 1014 and a data storage module 1015 electrically connected with the first micro-processing module 1011. The first micro-processing module 1011 may control the power loop switch module 1013 to turn on or turn off and may be implemented by a microprocessor control unit (MCU), a central processing unit (CPU), a microprocessor unit (MPU), or a digital signal processor (DSP).

The first signal transceiver module 1012 is used for detecting a wireless signal and may only detect such wireless signal within a specific range. The first signal transceiver module 1012 may be a Wireless Fidelity (Wi-Fi), a Bluetooth or an Infrared (IR) transmission device. The specific range may change based on different transmission technologies of the first signal transceiver module 1012 or based on system operator setting.

Furthermore, the power monitor device 101 establishes an information connection with the mobile communication device 102 via the first signal transceiver module 1012. The power loop switch module 1013 is disposed in a power loop of the power supply end 20 and the power user end 30.

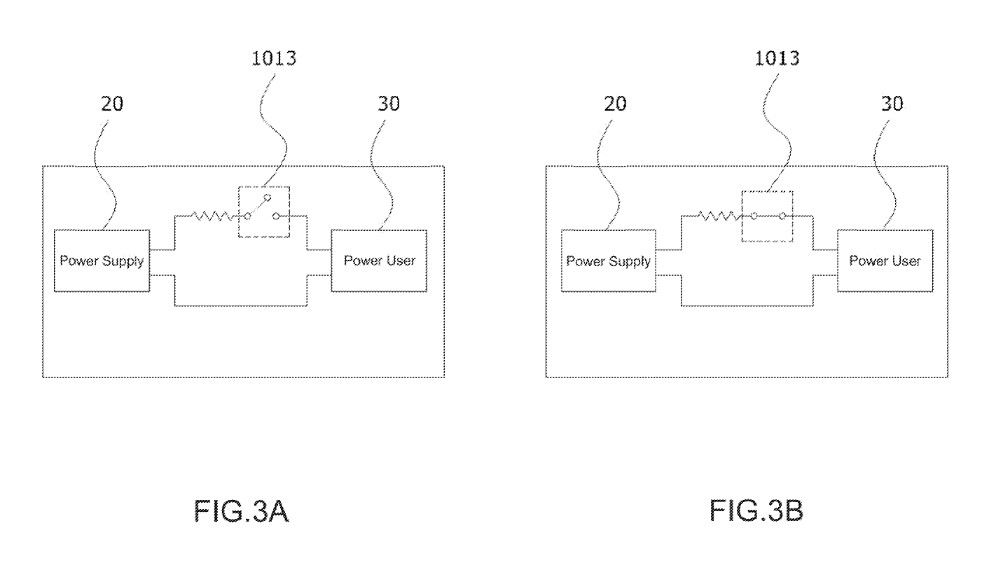

Please refer to FIG. 3A, which is a first power loop diagram of a preferred embodiment. As illustrated in the drawing, when the power loop switch module 1013 is turned on, the power loop forms an open status, i.e. the circuit being cut off and failing to form a loop, the power user end 30 no longer receives power from the power supply end 20. Without electric current flowing to the power user end 30, the power user end 30 cannot work. Furthermore, please refer to FIG. 3B, which is a second power loop diagram of an embodiment. As illustrated in the drawing, when the power loop switch module 1013 is ‘closed’, the power loop forms a close status. As such, the power user end 30 receives power from the power supply end 20, which means electric current flowing to the power user end 30, so that the power user end 30 may enter a work mode.

The power detection module 1014 may be an ampere meter or a voltage meter for detecting current or voltage of power supply. In other words, the power detection module 1014 may detect and monitor the power use status of the power user end 30 and generate power use data to be stored in data storage module 1015.

The mobile communication device 102 may be a smart phone, a personal digital assistant (PDA), a tablet computer or any other device. The mobile communication device 102 includes a second micro-processing module 1021 and a second signal transceiver module 1022 electrically connected with the second micro-processing module 1021. The mobile communication device 102 may also include a power monitor setting module 1023 connected with the second micro-processing module 1021 via information. The second micro-processing module 1021 may be a microprocessor control unit (MCU) for handling instructions from the power monitor setting module 1023.

The second signal transceiver module 1022 is used for sending a wireless signal, which may be a Wi-Fi, Bluetooth, IR transmission signal. When the power monitor setting module 1023 is executed, the second signal transceiver module 1022 is driven to send the wireless signal. The wireless signal may be encoded by the power monitor setting module 1023 so that the wireless signal may include a device identity information of the mobile communication device 102 like an International Mobile Equipment Identity Number (IMEI) or a Media Access Control (MAC) address. When the first signal transceiver module 1012 of the power monitor device 101 detects the wireless signal, the mobile communication device 102 and the power monitor device 101 establish an information connection. The first micro-processing module 1011 further decodes the wireless signal to retrieve the device identity information of the mobile communication device 102 and stores the data to the data storage module 1015 for the power monitor device 101 to tie with the mobile communication device 102.

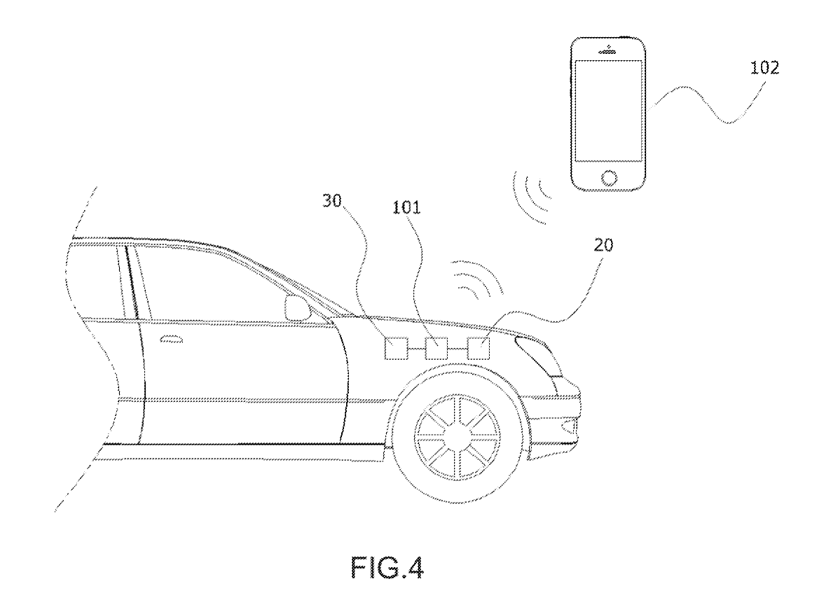

Please refer to FIG. 4, which is a first implementation diagram of a preferred embodiment. As illustrated in the drawing, in the illustrated embodiment, the intelligent power monitor system 10 may be applied in a vehicle like a motorcycle or a car. In the example of a car, the power monitor device 101 is installed in an engine ignition system, i.e. being disposed between the power supply end 20 and the power user end 30. The power supply end 20 may be a car battery and the power user end 30 may be an ignition coil. Nevertheless, any device to start a car may be used following the same invention spirit.

When completing to establish an information connection between the power monitor device 101 and the mobile communication device 102, the ignition coil of the engine ignition system may work normally for a user to start a car. The power monitor device 101 may use device identity information like IMEI or MAC address stored in the data storage module 1015 to be tied with the mobile communication device 102.

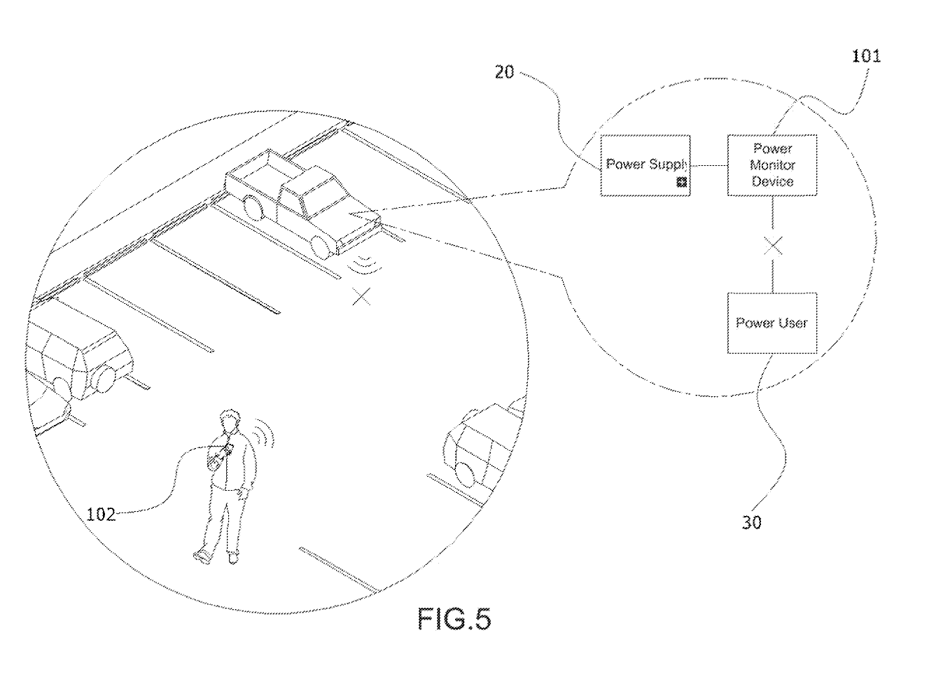

Please refer to FIG. 5, which is a second implementation diagram of a preferred embodiment. As illustrated in the drawing, when a user arrives a destination and leaves a car so that the distance between the mobile communication device 102 and the power monitor device 101 is longer than the specific range, the first signal transceiver module 1012 of the power monitor device 101 cannot receive the wireless signal from the second signal transceiver module 1022 of the mobile communication device 102 so that the power monitor device 101 and the mobile communication device 102 form a disconnection status.

In the disconnection status, the first micro-processing module 1011 of the power monitor device 101 controls the power loop switch module 1013 for switching to the ‘open’ status to cut the power loop. The ignition coil no longer receives power from the power supply end 20 and thus stops working. Therefore, when a thief tries to use a fake key or to hack the ignition system to steal the car, because the car is in a status of no power supply, lost prevention is improved. Furthermore, the user only needs to carry the mobile communication device 102 away the car, the power monitor device 101 cuts off the power automatically to largely increase use convenience.

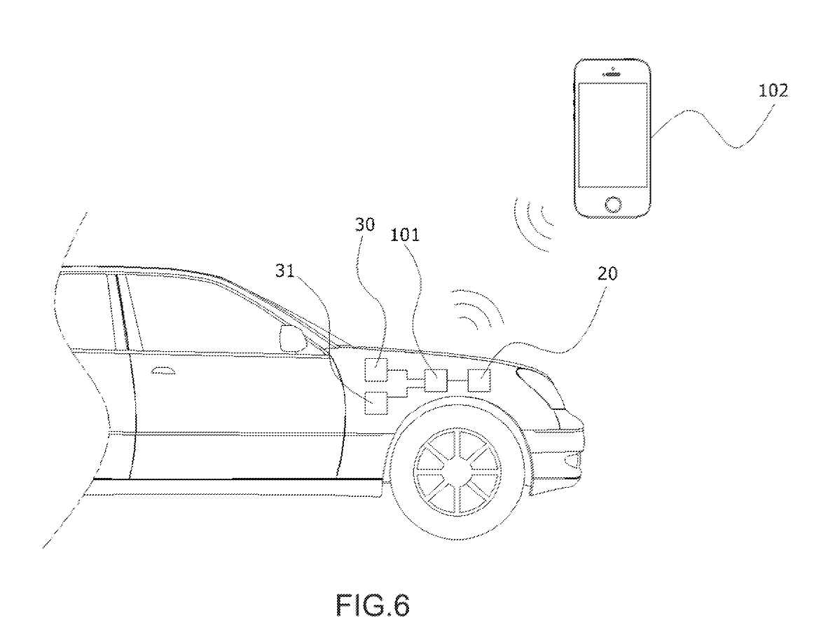

Please refer to FIG. 6, which is a third implementation diagram of a preferred embodiment. In the drawing, the power monitor device 101 of the embodiment may be installed between multiple power user ends 30, 31 and the power supply end 20. For example, the power user end 30 may be a car ignition system and the power user end 31 may be a car door lock system. In other words, the embodiment may not only serve for automatically power-on and power-off but also be used for automatically locking and unlocking.

When the first signal transceiver module 1012 of the power monitor device 101 does not receive the wireless signal from the second signal transceiver module 1022 of the mobile communication device 102, the power monitor device 101 and the mobile communication device 102 are in a disconnected status. In the disconnected status, the car ignition system does not work normally because the power loop switch module 1013 is in the ‘open’ status. Meanwhile, the car door lock system keeps the car door in a lock mode when the power loop switch module 1013 is in the ‘open’ status.

On the other hand, when the first signal transceiver module 1012 of the power monitor device 101 receives the wireless signal from the second signal transceiver module 1022 of the mobile communication device 102, in addition that the car ignition system recovers back to a normal use mode, the car door lock system is turned into an unlock status and unlocks the door when the power loop switch module 1013 is in the ‘close’ status. In addition to the automatic locking and unlocking, a car door lock control software may be installed in the mobile communication device 102 for the user to manually lock or unlock the car door. Therefore, the embodiment may be used as a keyless of a vehicle like a car.

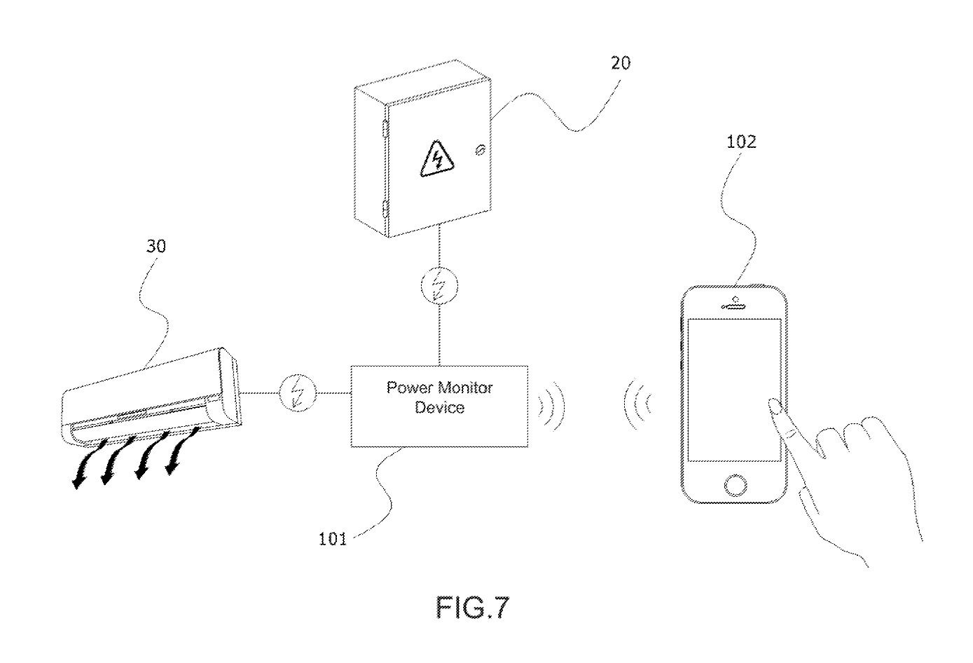

Please refer to FIG. 7, which illustrates a first implementation diagram of another embodiment. As illustrated in the drawing, the intelligent power monitor system 10 in the embodiment is applied in a home appliance device. The power monitor device 101 is disposed between the power supply end 20 and the power user end 30. The power supply end 20 may be a home appliance electric box. Nevertheless, any type of power supply may be used under the same invention spirit. The power user end 30 may be an air condition device.

The user may execute the power monitor setting module 1023 on the mobile communication device 102 to drive the second signal transceiver module 1022 to send the wireless signal to the first signal transceiver module 1012 of the power monitor device 101. After the first signal transceiver module 1012 detects the wireless signal, the first signal transceiver module 1012 establishes an information connection with the second signal transceiver module 1022 so that the power monitor device 101 and the mobile communication device 102 can form a connection status. Under such connection status, the first signal transceiver module 1012 of the power monitor device 101 may continuously receive the wireless signal from the second signal transceiver module 1022 of the mobile communication device 102.

Under the connection status, the power loop switch module 1013 of the power monitor device 101 is in the ‘close’ status to make the power loop in close status so that the air condition device may receive power from the power supply end 20 and enters a working mode. At such time, the power detection module 1014 of the power monitor device 101 detects the power use status to generate power use data and store such data in the data storage module 1015.

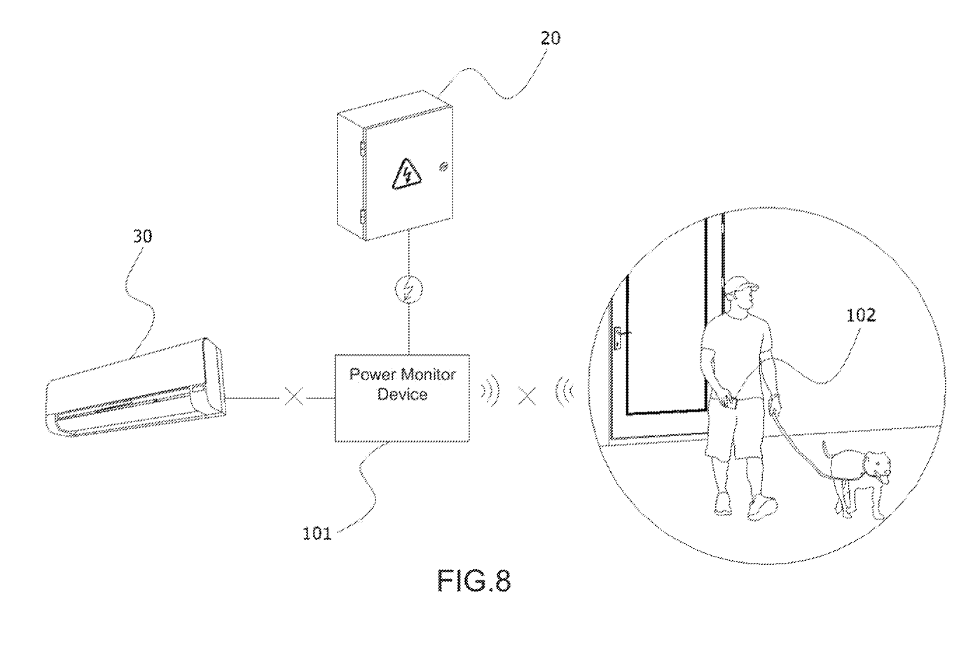

Please refer to FIG. 8, which is a second implementation diagram of another embodiment. As illustrated in the drawing, when the user carries the mobile communication device 102 outside a specific range detectable by the first signal transceiver module 1012, the first signal transceiver module 1012 cannot receive the wireless signal from the second signal transceiver module 1022 of the mobile communication device 102 and thus a disconnection status is formed between the power monitor device 101 and the mobile communication device 102. In the disconnection mode, the first micro-processing module 1011 of the power monitor device 101 controls the power loop switch module 1013 in the ‘open’ status to cut off the power loop and the air condition device fails to receive power from the power supply end 20 and stops working.

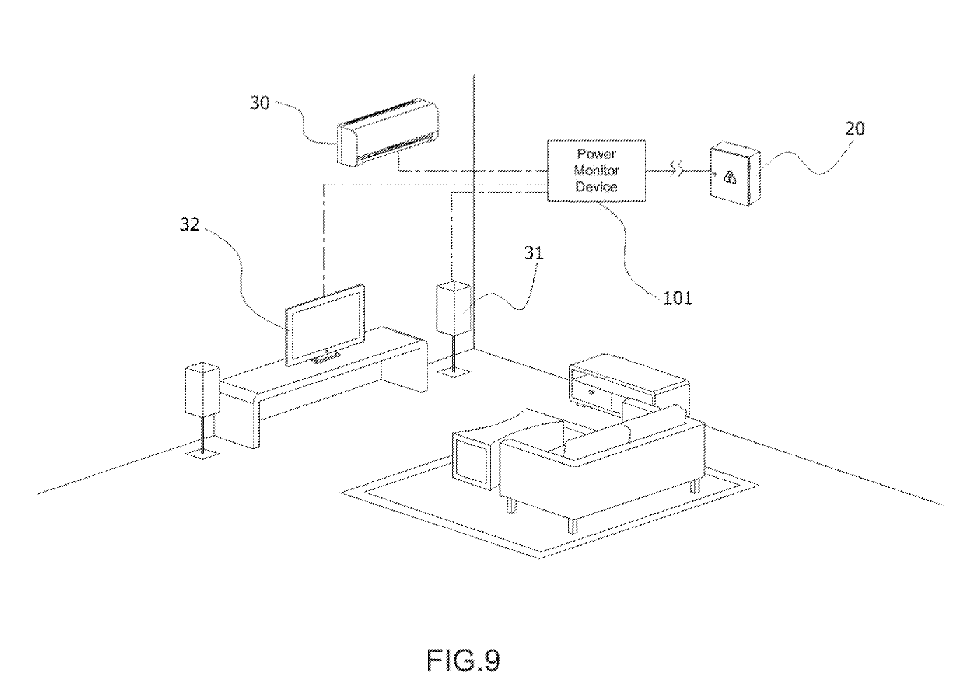

Please refer to FIG. 9, which is a third implementation diagram of another embodiment. As illustrated in the drawing, the power monitor device 101 may be disposed between multiple power user ends 30, 31, 32 and the power supply end 20. For example, an air condition device 30, a television 32 and a lamp 31 that consumes more power and easily forgot to be turned off by users may be selected as the objects. When the power monitor device 101 and the mobile communication device 102 form the disconnection mode, the power loop switch module 1013 of the power monitor device 101 forms an open loop and thus the air condition device 30, the television 32 and the lamp 31 fail to receive power from the power supply end 20 and stops working. The wireless signal of the mobile communication device 102 is used as a basis for automatically power-off to save power and provides a more convenient way for users so that the users do not need to turn off multiple power user ends 30, 31, 32 separately.

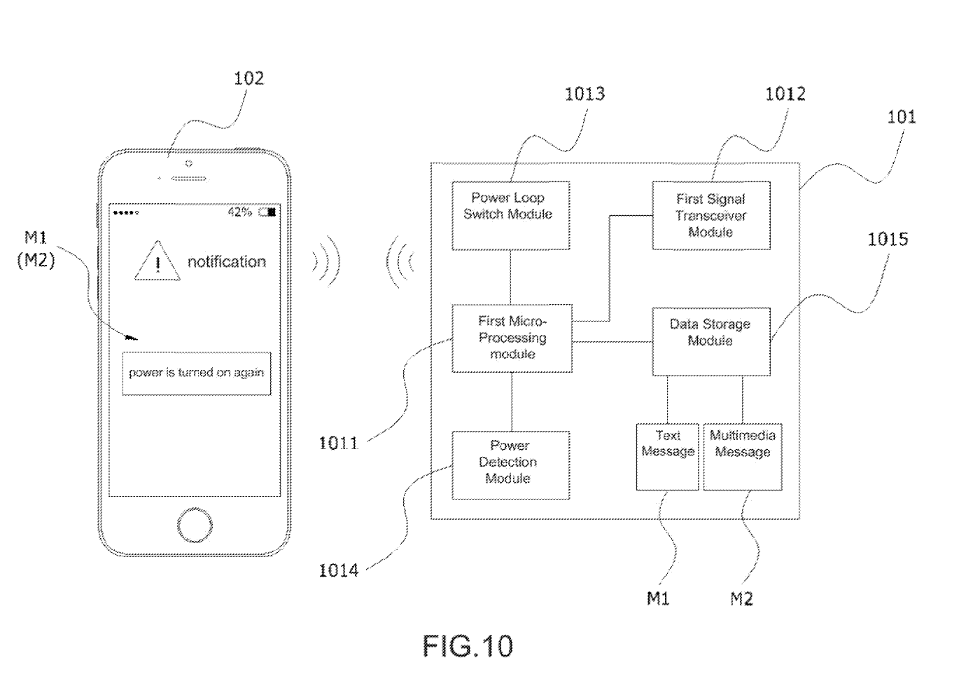

Please refer to FIG. 10, which is a fourth implementation diagram of another embodiment. As illustrated in the drawing, when the power monitor device 101 and the mobile communication device 102 are in the connection mode, the power monitor device 101 may send the power use data stored in the data storage module 1015 to the mobile communication device 102 so that the users may check the power use status of the power user end 30, e.g. how much energy being used by the air condition device.

Furthermore, the data storage module 1015 may store multiple notification messages that can be a text message M1 or a multimedia message M2. The text message M1 may be a SMS format message and the multimedia message M2 may be a MMS format message. When the power monitor device 101 and the mobile communication device 102 switch from a disconnection mode to a connection mode, the power loop switch module 1013 is switched from the open status to the close status. The first micro-processing module 1011 of the power monitor device 101 enables the first message transceiver module 1012 to send the notification message to the mobile communication device 102, like “Dear Sir, this is the reminder that the power is turned on again”, to remind the user that the power user end 30 receives power again and recovers to the working mode.

The first message transceiver module 1012 may also transmit the text message M1 or the multimedia message M2 with social network message or instant message software like Line, WhatsAPP, wechat, etc. to the mobile communication device 102 which is an intellectual mobile device via a wireless network connection device (not shown) using IFTTT (if this then that) network service platform.

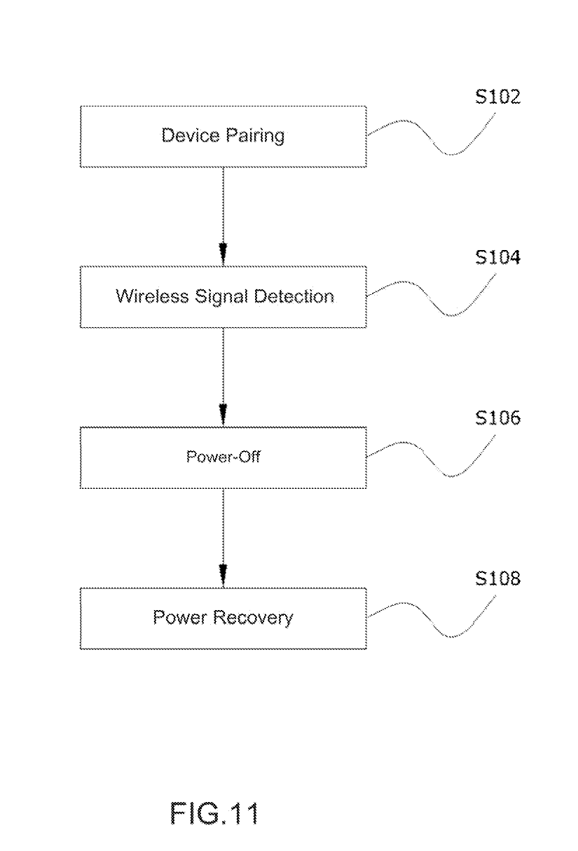

Please refer to FIG. 11, which is am implementation flowchart of a preferred embodiment. As illustrated in the drawing, the implementation method of the intelligent power monitor system 10 may further include following steps in addition to dispose the power monitor device 101 of the intelligent power monitor system 10 between the power supply end 20 and the power user end 30.

In a device pairing step (S102), a user executes the power monitor setting module 1023 on the mobile communication device 102 to drive the second signal transceiver module 1022 to send the wireless signal carrying device identity information like IMEI to the first signal transceiver module 1012 of the power monitor device 101. When the first signal transceiver module 1012 detects the wireless signal in the specific range, i.e. to establish an information connection with the second signal transceiver module 1022, a connection status is formed and the device identity information is used for tying the mobile communication device 102.

In a wireless signal detection step (S104), the first signal transceiver module 1012 of the power monitor device 101 continuously detects and receives the wireless signal from the mobile communication device 102. If the connection status is kept, the first micro-processing module 1011 of the power monitor device 101 controls the power loop switch module 1013 in the ‘close’ mode so that the power loop forms a close status illustrated in FIG. 3B. In such time, the power user end 30 receives power from the power supply end 20. For example, the air condition device and the car may be operated normally illustrated in FIG. 4 and FIG. 7. The power detection module 1014 of the power monitor device 101 may detect the power use status of the power user end 30 to generate power use data and store the power use data in the data storage module 1015.

In a power-off step (step S106), when the user carries the mobile communication device 102 away from the specific range, the first signal transceiver module 1012 of the power monitor device 101 does not detect the wireless signal in the specific range, i.e. a disconnection status with the mobile communication device 102 being formed. In the disconnection status, the first micro-processing module 1011 of the power monitor device 101 controls the power loop switch module 1013 in the open status illustrated in FIG. 3A. In such time, the power user end 30 no longer receives power from the power supply end 20. When no current is flowing to the power user end 30, the power user end 30 cannot work like a car does not function illustrated in FIG. 5 or the air condition does not work.

In a power recovery step (step S108), after the power-off step (S106), when the first signal transceiver module 1012 of the power monitor device 101 again detects the wireless signal from the mobile communication device 102 so that the connection between the power monitor device 101 and the mobile communication device 102 switches from the connection status to the disconnection status, the power monitor setting module 1023 of the mobile communication device 102 uses the second signal transceiver 1022 to send a driver signal to drive the first micro-processing module 1011 to control the power loop switch module 1013 to switch from the open status to the close status so as to recover power supply when the power loop recovers to the close status.

Please refer to FIG. 11, is an implementation flowchart of a preferred embodiment, which illustrates another embodiment that the power-off step (S106) may further include a power detection step. Specifically, when the user carries the mobile communication device 102 away so that the first signal transceiver module 1012 of the power monitor device 101 does not detect the wireless signal in the specific range and forms the disconnection status to the mobile communication device 102, the power detection module 1014 starts detecting the power use status during the disconnection status to generate power use data like current value. When the power use status is abnormal, i.e. the power use data equal or exceed a predetermined use data, e.g. power user end 30 having larger current value than predetermined current value during the disconnection status, the first micro-processing module of the power monitor device 101 controls the power loop switch module 1013 in the open status. At such time, the power user end 30 no longer receives power from the power supply end 20.

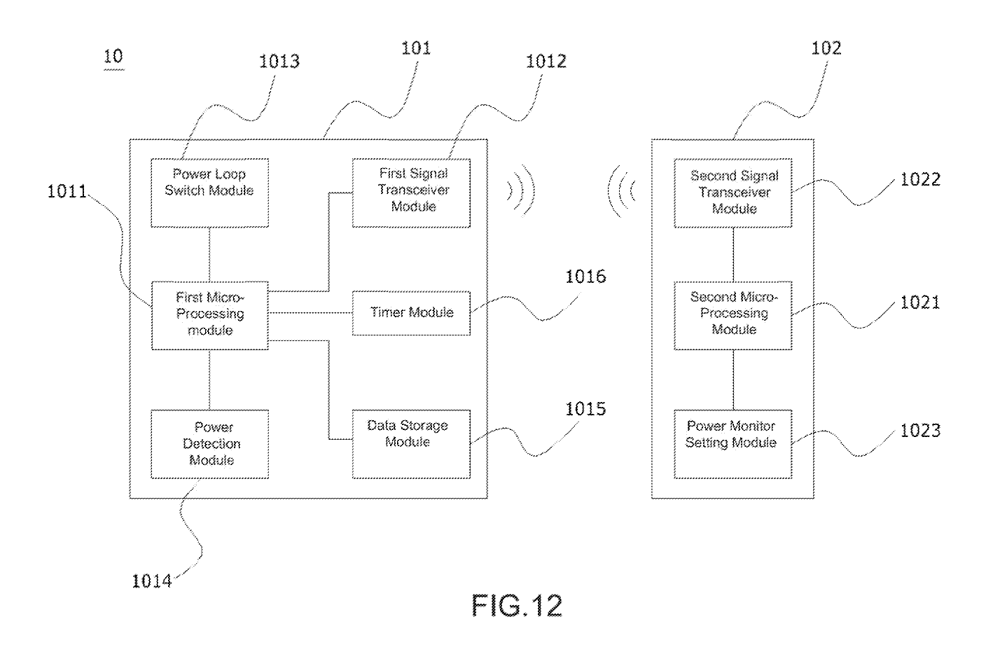

Please refer to FIG. 12, which illustrates a first system diagram of another embodiment. As illustrated in the drawing, the power monitor device 101 further includes a timer module 1016 having an information connection with the first micro-processing module 1011. The timer module 1016 may be used for setting and calculating a specific time. The power-off step (S106) may include a timer step. Specifically, when the first signal transceiver module 1012 of the power monitor device 101 does not receive the wireless signal in the specific range and forms the disconnection status with the mobile communication device 102, the timer module 1016 starts counting a power-off time. When the power-off time equals or exceeds a specific time period, e.g. the power-off time longer than five minutes, the first micro-processing module 1011 of the power monitor device 101 controls the power loop switch module 1013 in the open status. As such, not only the wireless signal of the mobile communication device 102 together with the power use data like the detected current value as determination basis for automatic power-off but also the wireless signal of the mobile communication device 102 together with the power-off time after disconnection may be used as determination basis for determining automatic power-off.

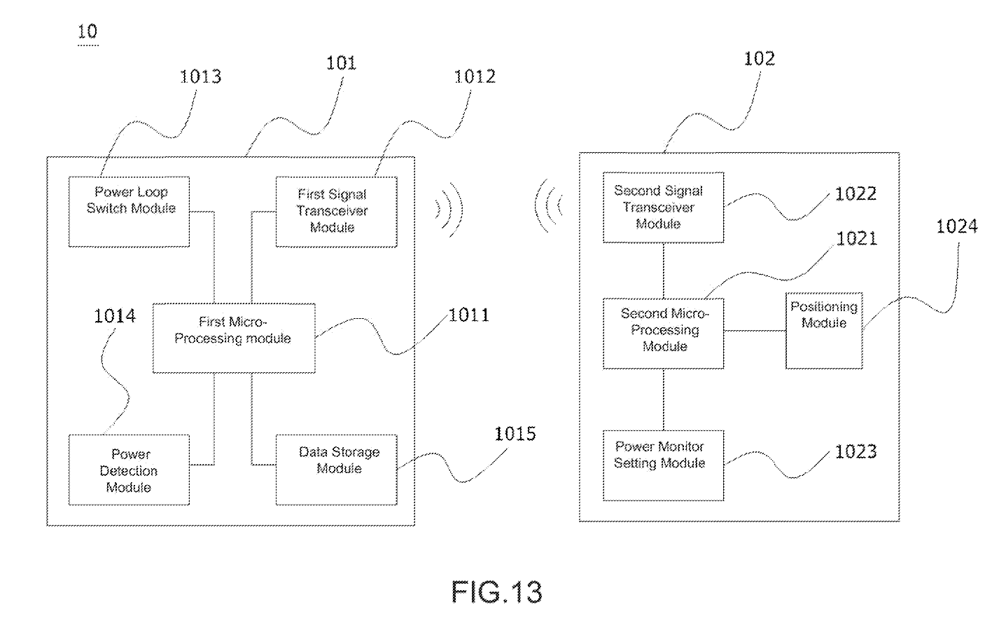

Please refer to FIG. 13, which is a second system diagram of another embodiment. As illustrated in the drawing, the mobile communication device 102 may further include a positioning module 1024 connected with the second micro-processing module 1021 via information. The positioning module 1024 may use Global Positioning System (GPS) for positioning of a position coordinate. When the first signal transceiver module 1012 does not receive the wireless signal from the second signal transceiver module 1022, i.e. the mobile communication device 102 and the power monitor device 101 forming the disconnection status, the positioning module 1024 records the current coordinate of the mobile communication device 102. The position coordinate may be latitude and longitude values. Therefore, the embodiment may provide a user to quickly locate his car.

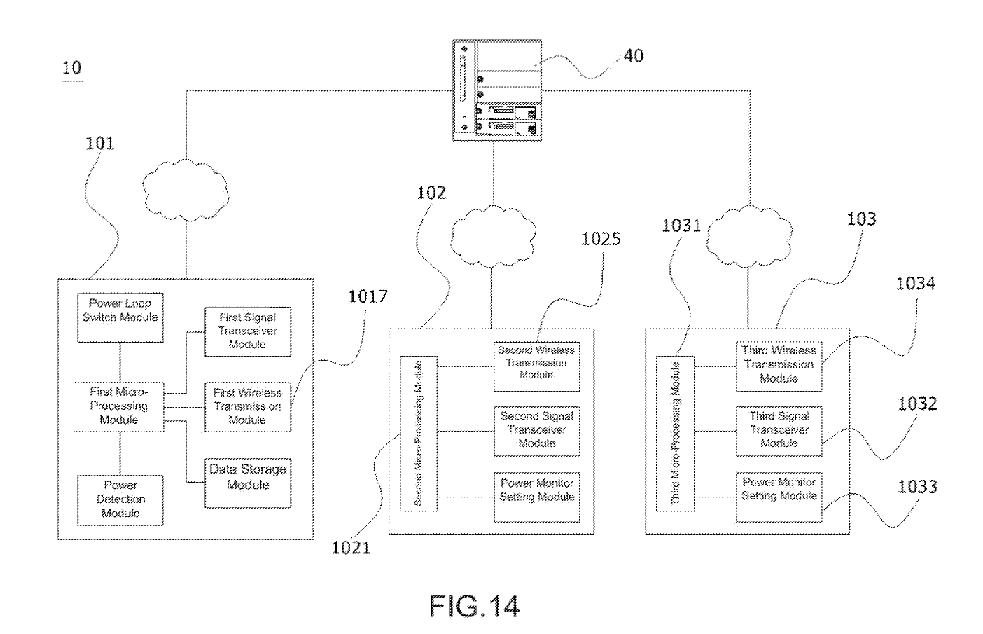

Please refer to FIG. 14, which is a third system diagram of another embodiment. As illustrated in the drawing, the mobile communication device 102 may further include a second wireless transmission module 1025 electrically connected with the second micro-processing module 1021. The second wireless transmission module 1025 may be connected with a service center server 40 via information, and the service center server 40 further connects with a first wireless transmission module 1017 of the power monitor device 101 to form a connection with the power monitor device 101 via information.

A user may send a register request to the service center server 40 to upload user identity data to the service center server 40. The identity data may include device identity information, user account and password of the mobile communication device 102. Therefore, the user may send commands to the power monitor device 101 by logging to the service center server 40.

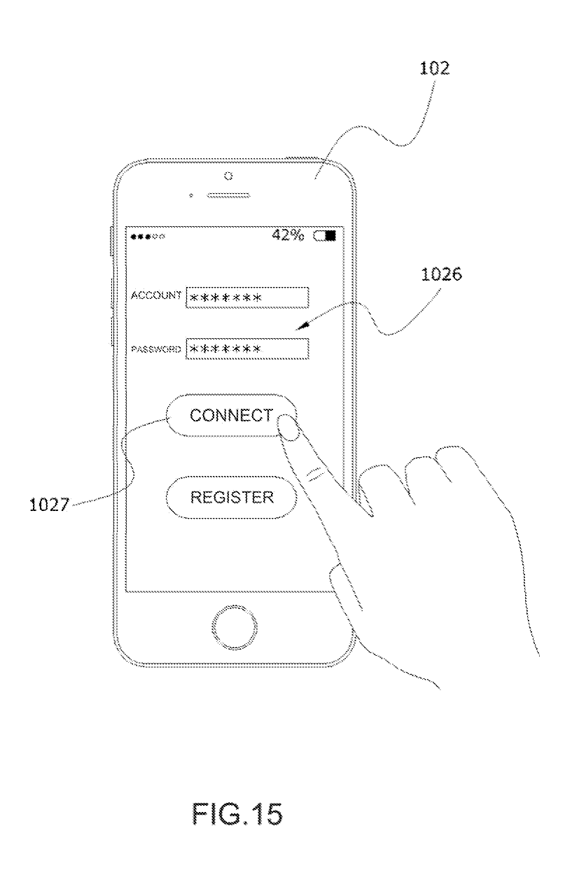

When the user goes out but not carrying the mobile communication device 102, because the power monitor device 101 and the mobile communication device 102 keep the connection status, the power monitor device 101 continuously keeps the power loop switch module 1013 in the close status. Please refer to FIG. 15, which illustrates a first implementation diagram of another system structure embodiment. In such case, the user uses a third wireless transmission module 1034 of another mobile communication device 103 to connect to the service center server 40, enters identity authentication data like user account and password, and clicks connection option 1027 to establish connection. After the connection is established, the user can control the power monitor device 101 via the service center server 40.

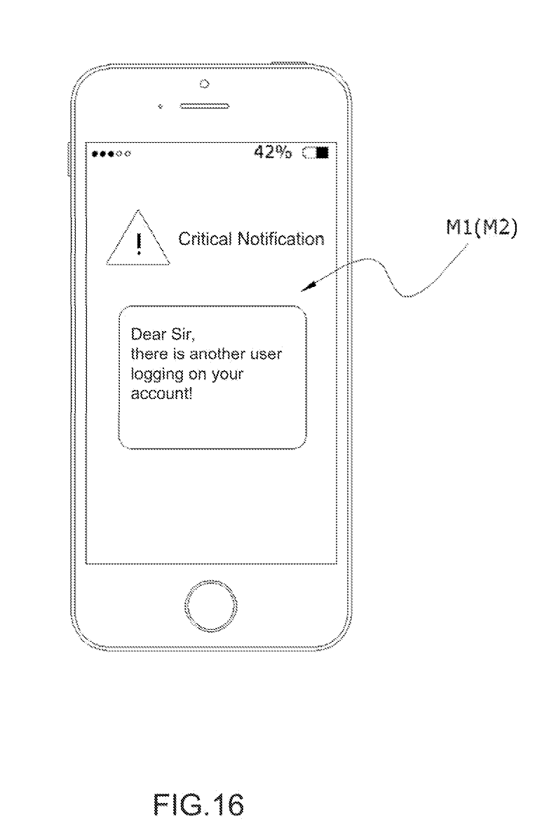

Please refer to FIG. 16, which is a second implementation diagram of another system structure embodiment. As illustrated in the drawing, when the service center server 40 finds another mobile communication device 103 having other device identity information different from that of the mobile communication device 102, e.g. different IMEI code, the service center server 40 sends a notification message like a text message M1 or a multimedia message M2 to the mobile communication device 102. For example, the message may be “Dear Sir, there is another user logging on your account” to enhance security of the power monitor system 10.

As mentioned above, the intelligent power monitor system and its implementation method include a power monitor device and a mobile communication device. The power monitor device is disposed between a power supply end and a power user end. The power monitor device has a first micro-processing module. The power monitor device further has a first signal transceiver module, a power loop switch module, a power detection module and a data storage module electrically connected to the first micro-processing module. Besides, the mobile communication device has a second micro-processing module and a second signal transceiver module electrically connected with the second micro-processing module. The mobile communication device further has a power monitor setting module connected with the second micro-processing module via information. When the power monitor setting module is executed, the second signal transceiver module is driven to send a wireless signal to the first signal transceiver module of the power monitor device. When the first signal transceiver module detects the wireless signal, an information connection is formed with the second signal transceiver module and a connection status is formed. In the connection status, the power loop switch module is switched in a ‘close’ status to make the power loop as a close loop. Meanwhile, the power detection module detects power use status to generate power use data to be stored in the data storage module. When the first signal transceiver module does not receive the wireless signal from the second signal transceiver module, a disconnection status is formed. In the disconnection status, the power loop switch module is switched in an ‘open’ status and makes the power loop as an open status. Accordingly, the aforementioned embodiments provide intelligent power monitor systems and their implementation methods for automatic power-off based on detection of wireless signals of mobile communication devices.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An intelligent power monitor system, comprising:
a power monitor device disposed between a power supply end and a power user end, the power monitor device having a first micro-processing module, a first signal transceiver module and a power loop switch module, the first micro-processing module being respectively electrically connected to the first signal transceiver module and the power loop switch module, the first micro-processing module controlling the power loop switch module to form a close status or an open status, the first signal transceiver module being used for detecting a wireless signal, when the wireless signal being detected by the first signal transceiver module, the first micro-processing module controlling the power loop switch module to form the close status, and when the wireless signal not detected by the first signal transceiver module, the first micro-processing module controlling the power loop switch module to form the open status;
a mobile communication device having a second micro-processing module, a second signal transceiver module and a power monitor setting module, the second signal transceiver module being electrically connected to the second micro-processing module, the power monitor setting module being connected to the second micro-processing module via information, and after the power monitor setting module being executed, the second signal transceiver module sending the wireless signal.

2. The intelligent power monitor system of claim 1, wherein the power monitor device has a power detection module connected with the first micro-processing module of the power monitor device via information, and the power detection module is used for detecting power use status of the power user end to generate power use data.

3. The intelligent power monitor system of claim 2, wherein the power monitor device has a data storage module connected with the first micro-processing module of the power monitor device via information, and the data storage module stores the power use data.

4. The intelligent power monitor system of claim 3, wherein the data storage module stores a notification message, and the first micro-processing module of the power monitor device enables the first signal transceiver module sending the notification message to the mobile communication device.

5. The intelligent monitor system of claim 1, wherein the power monitor device has a timer module connected with the first micro-processing module of the power monitor device via information, and the timer module is used for setting and calculating a specific time period.

6. The intelligent monitor system of claim 5, wherein when a time period for the power monitor device not detecting the wireless signal equals or exceeds the specific time period, the first micro-processing module controls the power loop switch module to form the open status.

7. The intelligent monitor system of claim 1, wherein the mobile communication device has a positioning module connected with the second micro-processing module via information, and when the first signal transceiver module of the power monitor device does not detect the wireless signal, the positioning module locates the mobile communication device to obtain a coordinate position.

8. The intelligent power monitor system of claim 1, wherein the power monitor device has a first wireless transmission module, the first wireless transmission module is electrically connected with the first micro-processing module, the mobile communication device has a second wireless transmission module, and the second wireless transmission module is electrically connected with the second micro-processing module.

9. The intelligent power monitor system of claim 8, wherein the mobile communication device is connected with a service center server via the second wireless transmission module, and the service center server is connected to the power monitor device via the first wireless transmission module via information to control the power monitor device.

10. A method for implementing an intelligent power monitor system, a power monitor device of the intelligent power monitor system being disposed between a power supply end and a power user end, the implementing method comprising:
a device pairing step, wherein a mobile communication device drives a second signal transceiver module via a power monitor setting module to send a wireless signal, and after a first signal transceiver module of the power monitor device receives the wireless signal, an information connection to the mobile communication device is established to form a connection status;
a wireless signal detection step, wherein the power monitor device keeps the information connection with the mobile communication device, the first signal transceiver module of the power monitor device continuously receives the wireless signal sent by the second signal transceiver module of the mobile communication device, and under the connection status, a first micro-processing module of the power monitor device controls a power loop switch module of the power monitor device to form a close status;
a power-off step, wherein when the first signal transceiver module of the power monitor device does not detect the wireless signal, the power monitor device and the mobile communication device is under a disconnection status, and under the disconnection status, the first micro-processing module controls the power loop switch module to form an open status.

11. The implementing method of claim 10, wherein a power-recovery step is continued after the power-off step, and the power-recovery step comprises when the first signal transceiver module of the power monitor device detecting the wireless signal again to recover the connection status of the power monitor device and the mobile communication device, the power monitor setting module sending a driver signal via the second signal transceiver module to drive the first micro-processing module to control the power loop switch module to switch from the open status to the close status.

12. The implementing method of claim 11, wherein when the power loop switch module is switched from the open status to the close status, the first micro-processing module of the power monitor device enables the first signal transceiver module to send a notification message stored in a data storage module to the mobile communication device.

13. The implementing method of claim 10, wherein the power-off step comprises a power detection step, and the power detection step comprises when the first signal transceiver module of the power monitor device not detecting the wireless signal, a power detection module of the power monitor device starting detecting power use status of the power user end to generate power use data, and when the power use data equal or exceed predetermined use data predetermined by the power detection module, the first micro-processing module controlling the power loop switch module to form the open status.

14. The implementing method of claim 10, wherein the power-off step comprises a timer step, and the timer step comprises when the first signal transceiver module of the power monitor device not detecting the wireless signal, a timer module of the power monitor starting counting a power-off time, and when the power-off time equals or exceeds a specific time period predetermined by the timer module, the first micro-processing module controlling the power loop switch module to form the open status.
